(19) United States
(12) Patent Application Publication
(10) Pub. No.: US 2012/0105608 A1
(43) Pub. Date: May 3, 2012

(54) METHOD, SHUTTER GLASSES, AND APPARATUS FOR CONTROLLING ENVIRONMENT BRIGHTNESS RECEIVED BY SHUTTER GLASSES

(75) Inventor: Chueh-Pin Ko, New Taipei City (TW)

(73) Assignee: ACER INCORPORATED, New Taipei City (TW)

(21) Appl. No.: 13/105,859

(22) Filed: May 11, 2011

(30) Foreign Application Priority Data
Nov. 2, 2010 (TW) 099137691

(51) Int. Cl. H04N 13/04

(52) U.S. Cl. 348/54; 348/E13.026

(57) ABSTRACT

A method for controlling an environment brightness received by shutter glasses which are used to view images presented by a display device is provided. The method includes the following steps: generating a control signal according to image variations of image content presented by the display device, external environment brightness, or an instruction signal for controlling an operation of the shutter glasses; and adjusting activation time of the shutter glasses to adjust the environment brightness received by shutter glasses according to the controlling signal.

### BACKGROUND OF THE INVENTION

1. Field of the Invention

The present invention relates to a control mechanism of three-dimensional (3D) glasses, and more particularly, to a method and device for controlling environment brightness received by 3D glasses.

2. Description of the Prior Art

With the development of science and technology, users are pursing stereoscopic and more real image displays rather than high quality images. There are two techniques employed by the present stereo image display. One is to use a video output apparatus which collaborates with glasses (e.g., anaglyph glasses, polarization glasses, or shutter glasses), while the other is to directly use a video output apparatus without any accompanying glasses. No matter which technique is utilized, the main principle of stereo image display is to make the left eye and the right eye see different images, thus the brain will regard the different images seen from two eyes as stereo images.

For shutter glasses, they are widely used for users to view stereo images presented by a video output apparatus. The shutter glasses include two shutter lenses, and allow user's left eye to see left-eye images and user's right eye to see right-eye images by properly switching the shutter lenses between an on state (or called open state) and an off state (or called close state). In general, two shutter lenses of the shutter glasses are turned on, alternately. For example, when the shutter lens corresponding to user's left eye is in an on state, the shutter lens corresponding to user's right eye is in an off state, and vice versa. Therefore, the ambient brightness perceived by the user is lower than real ambient brightness. On the other hand, according to the polarization direction of an image light output presented by the video output apparatus, the shutter lenses of the shutter glasses used to collaborate with the video output apparatus have a related polarization setting. However, ambient light includes light beams of different angles. When the shutter lens of the shutter glasses is in an on state, only light beams which conform to the polarization setting of the shutter lens will penetrate through the shutter lens. As a result, the ambient brightness perceived by the user is lower than the real ambient brightness.

Furthermore, when the user is wearing shutter glasses, the brightness of a display area perceived by the user (e.g., the brightness of stereo images presented by the display screen) may be different from the environment brightness beyond the display area perceived by the user through shutter glasses (i.e., brightness of an ambient environment that does not belong to the display area). For example, ambient environment brightness is not particularly polarized, thus, the polarizers included in the structure of the well-known shutter glasses cause a large attenuation to the environment brightness. For example, when the liquid crystal (LC) layer in the lens structure of the shutter glasses is in the on state, at least 50% of the environment light is filtered out by the polarizers. As a result, only 35%-40% of the original environment brightness finally reaches user's eyes (i.e., regarding the environment light, light transmission rate of the shutter lens under the on state is about 35%-40%). Besides, as to the video output apparatus (e.g., a display apparatus using linear polarization or circular polarization), an image light output corresponding to the stereo image has a certain polarization direction. The lens structure of the well-known shutter glasses used to collaborate with the video output apparatus has polarizers with the same polarization direction. Therefore, the polarizers in the lens structure of the shutter glasses will not cause a large attenuation to the brightness of the original image light output. For example, when the LC layer in the lens structure of the shutter glasses is in the on state, only 10%-20% of the brightness of the display area is attenuated by the polarizers. Thus, 65%-70% of the original brightness of the display area finally reaches user's eyes (i.e., as to the image light output generated in the display area, the light transmission rate of the shutter lens under the on state is about 65%-70%). Besides, since the shutter lens switches between the on state and the off state periodically rather than always stays in the on state, the environment brightness beyond the display area perceived by the user through the shutter glasses is influenced by the real activation time of the shutter lens. Therefore, the brightness finally perceived by the user (i.e., light transmission rate of the shutter lens) may be regarded as the light transmission rate of the shutter lens under the on state times the ratio of the activation time of the shutter lens to the total glasses time (suppose that the LC layer in the shutter lens may block any light transmission when staying in the off state). For example, the light transmission rate of the shutter lens under the on state for the environment light is 35%, and the light transmission rate of the shutter lens under the on state for the image light output generated in the display area is 70%. Therefore, when the ratio of the activation time of shutter lens to the total glasses time is 16%, the brightness of the display area finally perceived by the user is 11.2% (i.e., 70%×16%); however, the environment brightness finally perceived by the user is only 5.6% (i.e., 35%×16%), leading to a problem that the environment brightness is too low.

The shutter lens control mechanism of the conventional shutter glasses only considers viewing of stereo images without having the environment brightness perceived by users taken into consideration. Therefore, it does not offer any adjusting function to the environment brightness perceived by users. If the user feels lack of environment brightness when wearing the shutter glasses, he/she may not identify items, such as a keyboard or remote control, beyond the screen of the video output apparatus clearly, leading to inconvenience in stereo image viewing for users.

### SUMMARY OF THE INVENTION

Therefore, one of the objectives of the present invention is to provide a method, 3D glasses and a device for controlling ambient environment brightness received by 3D glasses, in order to solve the problem described above.

According to a first aspect of the present invention, an exemplary method for controlling ambient environment brightness received by 3D glasses is provided. The 3D glasses are utilized for viewing an image presented by a display device. The exemplary method includes: generating a control signal according to image variations of a video content presented by the display device, an external ambient environment brightness or an instruction signal for controlling an operation of the 3D glasses; and adjusting an activation time of the 3D glasses according to the control signal, in order to adjust the ambient environment brightness received by the 3D glasses.

According to a second aspect of the present invention, an exemplary method for controlling ambient environment brightness received by the 3D glasses is provided. The 3D glasses are utilized for viewing images presented by a display device. The exemplary method includes: generating a control signal according to image variations of a video content presented by a display device, an external environment brightness or an instruction signal for controlling an operation of the 3D glasses; and outputting the control signal to the 3D glasses by wire or wireless network, generating an activation time of the 3D glasses, in order to adjust the ambient environment brightness received by the 3D glasses.

According to a third aspect of the present invention, an exemplary method for controlling ambient environment brightness received by 3D glasses is provided. The 3D glasses are utilized for viewing images presented by a display device. The exemplary method includes: receiving a control signal which is inputted externally; and according to the received control signal, adjusting an activation time of the 3D glasses, in order to adjust the ambient environment brightness received through the 3D glasses; wherein the control signal is corresponding to image variations of a video content presented by the display device, an external ambient environment brightness or an instruction signal for controlling an operation of the 3D glasses.

According to a fourth aspect of the present invention, 3D glasses for controlling ambient environment brightness received by 3D glasses are provided. The 3D glasses are utilized for viewing images presented by a display device, and include a control circuit and an adjusting circuit. The control circuit generates a control signal according to image variations of a video content presented by a display device, an external ambient environment brightness or an instruction signal for controlling an operation of the 3D glasses. The adjusting circuit is coupling to the control circuit, in order to adjust an activation time of the 3D glasses to adjust ambient environment brightness received by the 3D glasses according to the control signal.

According to a fifth aspect of the present invention, 3D glasses for controlling ambient environment brightness received by 3D glasses are provided. The 3D glasses are utilized for viewing images presented by a display device, and include a receiving circuit and an adjusting circuit. The receiving circuit is utilized for receiving a control signal which is inputted externally. The adjusting circuit is coupling to the receiving circuit, in order to adjust an activation time of the 3D glasses to adjust ambient environment brightness received by the 3D glasses according to the received control signal; wherein the control signal is corresponding to image variations of a video content presented by a display device, an external ambient environment brightness or an instruction signal for controlling an operation of the 3D glasses.

According to a sixth aspect of the present invention, a device for controlling ambient environment brightness received by 3D glasses is provided. 3D glasses are utilized for viewing images presented by a display device. The device includes a control circuit and an output circuit. The control circuit generates a control signal according to image variations of a video content presented by a display device, external ambient environment brightness or an instruction signal for controlling an operation of the 3D glasses. The output circuit is coupling to the control circuit for outputting control signal to the 3D glasses, wherein the control signal is for adjusting an activation time of the 3D glasses, in order to adjust ambient environment brightness received by 3D glasses. Besides, the device may be disposed within the display device or externally coupling to the display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a block diagram of an image display system according to a first exemplary embodiment of the present invention.

FIG. 1B is a flowchart illustrating an operation of 3D glasses in the image display system shown in FIG. 1A.

FIG. 1C is a flowchart illustrating an operation of the control circuit shown in FIG. 1A.

FIG. 2A is a diagram of using the 3D glasses shown in FIG. 1A to view a dual 2D video.

FIG. 2B is a diagram of the 3D glasses shown in FIG. 1A that are operated under the dual 2D video viewing mode.

FIG. 3 is a diagram of an image display system according to a second exemplary embodiment of the present invention.

FIG. 4 is a diagram of an image display system according to a third exemplary embodiment of the present invention.

### DETAILED DESCRIPTION

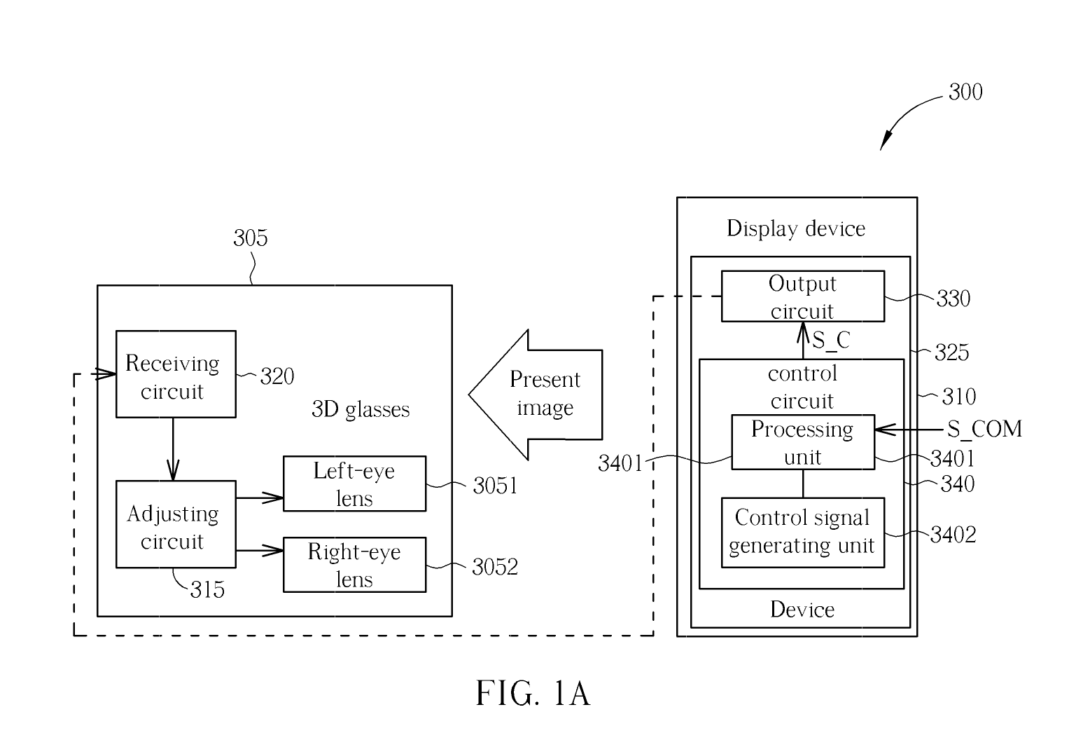

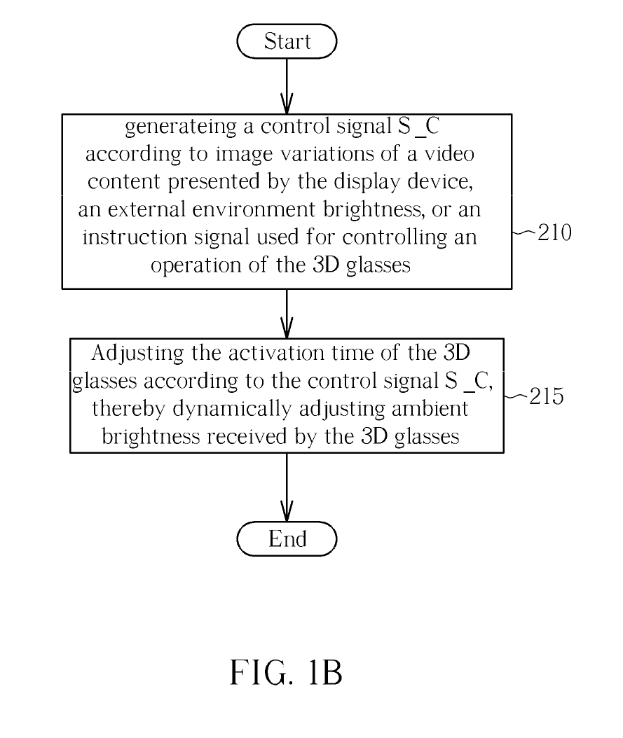

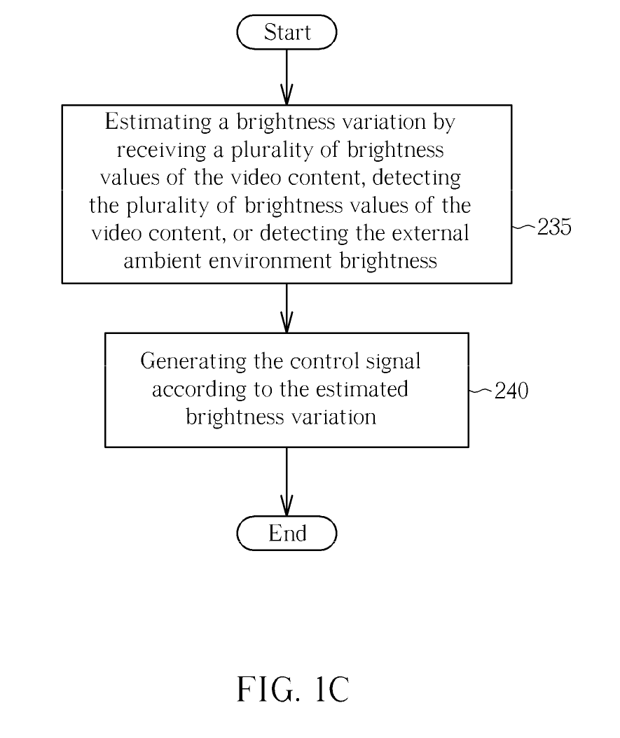

Please refer to FIG. 1A and FIG. 1B. FIG. 1A is a diagram of an image display system 300 according to a preferred embodiment of the present invention. FIG. 1B is a flowchart illustrating an operation of the image display system 300 shown in FIG. 1A. The image display system 300 includes 3D glasses 305 and a display device 310, wherein the 3D glasses 305 include a left-eye lens 3051, a right-eye lens 3052, an adjusting circuit 315 and a receiving circuit 320, and the display device 310 includes at least a device 325 utilized for controlling ambient environment brightness received by the 3D glasses 305. The device 325 includes an output circuit 330 and a control circuit 340, wherein the control circuit 340 includes a processing unit 3401 and a control signal generating unit 3402. The 3D glasses 305 are utilized for viewing images presented by the display device 310. As to viewing of the stereo images (3D images), the left-eye lens 3051 is for the user to view left-eye images, and the right-eye lens 3052 is for the user to view right-eye images. However, as to viewing of general two-dimensional (2D) images, the left-eye lens 3051 and the right-eye lens 3052 are both used for the user to view the same image. In this exemplary embodiment, the control circuit 340 generates a control signal S_C according to image variations of a video content presented by the display device 310 (e.g., a partial or overall change of the brightness, color, grey level (i.e., the histogram) or a variation of an image object (e.g., a human face or caption)), an external environment brightness, or an instruction signal S_COM used for controlling an operation of the 3D glasses (step 210). Next, the output circuit 330 transmits the control signal S_C to the 3D glasses 305 by wired or wireless transmission (e.g., infrared transmission, ZigBee transmission, ultrawideband (UWB) transmission, WiFi transmission, radio frequency (RF) transmission, DLP light signal transmission, or Bluetooth transmission). The receiving circuit 320 in the 3D glasses 305 receives the control signal S_C, and transmits the received control signal S_C to the adjusting circuit 315. Therefore, the adjusting circuit 315 dynamically adjusts the activation time of the left-eye lens 3051/right-eye lens 3052 according to the instruction of the control signal S_C, thereby dynamically adjusting ambient brightness received by the 3D glasses 305 (step 215). In other words, the control circuit 340 may generate the control signal S_C according to at least one of three different operating conditions (i.e., an image variation, an external environment brightness, and the instruction signal S_COM).

In this exemplary embodiment, the adjusting circuit 315 adjusts the light transmission rate of the left-eye lens 3051 and the right-eye lens 3052 according to the control signal S_C. For example, 3D glasses 305 are shutter glasses; thus, the left-eye lens 3051 and the right-eye lens 3052 are both shutter lenses. The left-eye lens 3051 and the right-eye lens 3052 switch between an on state and an off state, respectively. For example, the left-eye lens 3051 and the right-eye lens 3052 both have LC layers, and may control rotation of LC cells in the LC layers by voltage control to thereby achieve the objective of adjusting the light transmission rate. Since the number of shutter-on times and the number of shutter-off times, the ratio of the activation time to the inactivation time, and/or the glasses cycle (i.e., the cycle that the left eye and the right eye respectively view the image once) are adjustable, the objective of adjusting the ambient environment brightness perceived by the user is achieved. Please note that the detailed description directed to adjusting/increasing environment brightness by controlling shutter lens to switch between an on state and an off state may be readily known by referring to the same inventor's other U.S. patent applications which claim the benefit of counterpart Taiwanese patent applications (e.g., Taiwanese patent application NO. 099122342, Taiwanese patent application NO. 099124293 and Taiwanese patent application NO. 099126274), further description is omitted here for brevity. Please note that the above is only for illustrative purposes only, and is not meant a limitation of the present invention. For example, any structure capable of controlling the light transmission rate may be utilized for realizing the left-eye lens 3051 and the right-eye lens 3052. The same objective of controlling the ambient environment brightness received by the 3D glasses 305 (i.e., the environment brightness perceived by the user through the 3D glasses 305) is achieved. Besides, the 3D glasses 305 are not limited to shutter lenses. Any glasses that are utilized for viewing stereo images and have the function of adjusting environment brightness also obey the spirit of the present invention.

The 3D glasses 305 are designed to be worn by the user for allowing the user to view images (e.g., stereo images) presented by the display device 310. For example, in the exemplary embodiment shown in FIG. 1A, the display device 310 may be a liquid crystal display (LCD) apparatus that includes a display screen (e.g., an LCD panel) and a backlight module. The backlight module provides light source needed by the display screen. The 3D glasses 305 control whether an image light output generated by the display screen may reach the user's left eye or right eye. Please note that the display device 310 is not limited to an LCD apparatus. That is, the display device 310 may be any video output apparatus capable of collaborating with the 3D glasses 305 for presenting stereo images. For example, the display device 310 may be an organic light-emitting diode (OLED) display, a plasma display, a digital light processing (DLP) display/projector, or a liquid crystal on silicon (LCoS) display/projector. In other words, supposing that the 3D glasses 305 are shutter glasses, the display device 310 is any display device or projector that has a polarization characteristic (e.g., a linear polarization characteristic or circular polarization characteristic) and collaborates with the shutter glasses.

As to the exemplary embodiment of using shutter glasses as the 3D glasses 305, properly controlling the left-eye lens 3051 and the right-eye lens 3052 to switch between an on state and an off state may adjust the ambient environment brightness perceived by the user who is wearing shutter glasses. Besides, the display device 310 may communicate with the 3D glasses 305 through a signal transmitter. For example, the 3D glasses 305 (e.g., shutter glasses) may supports wired transmission (e.g., the 3D glasses 305 are connected to the display device 310 directly by a connection cable; besides, the 3D glasses 305 may also drain their own supply power from the display device 310 by the connection cable) or wireless transmission (e.g., infrared transmission, ZigBee transmission, ultrawideband (UWB) transmission, WiFi transmission, radio frequency (RF) transmission, DLP light signal transmission or Bluetooth transmission). Besides, the display device 310 may only provide a synchronization signal without giving the control setting which determines the timing when the left-eye lens 3501 and the right-eye lens 3502 should be turned on or turned off. Moreover, the signal transmitter described above may be connected to the display device 310 (e.g., a display/projector) externally; however, it may also be integrated/disposed within the display device 310 (e.g., a display/projector).

Please refer to FIG. 1C. FIG. 1C is a flowchart illustrating an operation of the control circuit 340 shown in FIG. 1A. In practice, the control circuit 340 includes a processing unit 3401 and a control signal generating unit 3402. In the first exemplary embodiment, the processing unit 3401 is utilized for analyzing an image variation of the video content, and calculating a brightness variation according to a resultant analyzing value derived from analyzing the image variation (step 235). The control signal generating unit 3402 generates the control signal S_C according to the calculated brightness variation (step 240). When the resultant analyzing value or the calculated brightness variation indicates that the brightness is increased, the control signal S_C generated by the control signal generating unit 3402 indicates that the activation time of the 3D glasses 305 should be increased, and the adjusting circuit 315 accordingly increases the activation time of the 3D glasses 305 in response to the instruction of the control signal S_C, in order to increase the ambient environment brightness received by the 3D glasses 305; when the resultant analyzing value or the calculated brightness variation indicates that the brightness is decreased, the control signal S_C generated by the control signal generating unit 3402 indicates that the activation time of the 3D glasses 305 should be decreased, and the adjusting circuit 315 accordingly decreases the activation time of the 3D glasses 305 in response to the instruction of the control signal S_C, in order to decrease the ambient environment brightness received by the 3D glasses 305.

According to the received image brightness values, the processing unit 3401 knows the brightness of the current image by analyzing a histogram of image brightness and grey level distribution. Since the processing unit 3401 may also analyze the brightness of the previous image, it may also know the brightness of the previous image. Therefore, the processing unit 3401 may know the image brightness variation of the video content. That is, the processing unit 3401 is capable of knowing whether the image brightness of the video content is increased or decreased. The processing unit 3401 may also knows the image brightness variation by using other analyzing manners; besides, the processing unit 3401 may also employ a more advanced image recognition manner to detect the brightness of objectives (e.g., human faces, vehicles, etc). However, this is for illustrative purposes only, and is not meant to be a limitation of the present invention.

In practice, when the display device 310 begins to play videos having dark scenes (e.g., a horror film), the processing unit 3401 detects the image brightness of the dark scenes, and then detects the image brightness (i.e., a darkened image) is decreased; additionally, the control signal S_C generated by the control signal generating unit 3402 indicates that a brightness is decreased. Therefore, the adjusting circuit 315 decreases the activation time of the 3D glasses 305, in order to decrease the ambient environment brightness received by the 3D glasses 305. Thus, when human eyes are viewing the video through the 3D glasses 305, they not only see a video of dark scenes presented by the display device 310, but also perceive that the environment brightness seen from the left-eye lens 3051 and the right-eye lens 3052 is also darkened. Besides, when the display device 310 begins to play videos having bright scenes (e.g., images with a sunny beach or a car rushing out of a tunnel), the processing unit 3401 detects the image brightness of the bright scenes, and then detects that the image brightness (i.e., a brightened image) is increased; additionally, the control signal S_C generated by the control signal generating unit 3402 indicates that a brightness is increased. Therefore, the adjusting circuit 315 increases the activation time of the 3D glasses 305, in order to increase the ambient environment brightness received by the 3D glasses 305. Thus, when human eyes are viewing the video through the 3D glasses 305, they not only see a video of bright scenes presented by the display device 310, but also perceive that the environment brightness seen from the left-eye lens 3051 and the right-eye lens 3052 is also brightened. Since the environment brightness seen by user's eyes is adaptively adjusted in response to the image brightness variation of the video content viewed by the user, the viewing quality is increased and the viewing experience (e.g., the personal presence) may be improved when the user is wearing the 3D glasses 305 to view the video content.

Besides, in the second exemplary embodiment, the processing unit 3401 estimates the brightness variation by detecting an external/outside ambient environment brightness (step 235), and the control signal generating unit 3402 generates a control signal S_C according to the estimated brightness variation (step 240). When it is detected that the environment brightness is increased, the control signal S_C generated by the control signal generating unit 3402 indicates that the activation time of the 3D glasses 305 is increased. When it is detected that the environment brightness is decreased, the control signal S_C generated by the control signal generating unit 3402 indicates that the activation time of the 3D glasses 305 is decreased. Thus, according to the instruction of the control signal S_C, the adjusting circuit 315 dynamically increases/decreases the activation time of the 3D glasses 305 to achieve the objective of dynamically adjusting the environment brightness received through the 3D glasses 305 and saving the power consumption of the 3D glasses 305. For example, when people are watching movies, they often decrease the brightness of the light in order to pay attention to the screen of the display device 310. The processing unit 3401 knows a low environment brightness by detecting the light source of the ambient environment, and then the control signal generating unit 3402 finds out a corresponding decreased environment brightness of the 3D glasses 305 by searching the look-up table and accordingly generates the control signal S_C. Next, the control signal S_C is transmitted to the adjusting circuit 315. Therefore, the adjusting circuit 315 may decrease the activation time of the left-eye lens/right-eye lens 3051, 3052 of the 3D glasses 305, in order to decrease the environment brightness received by the 3D glasses 305. Moreover, when people are watching normal TV programs, they often do not change the external environment brightness. The processing unit 3401 knows that the current ambient environment is brighter by detecting the light source of the external ambient environment, and the activation time of the left-eye lens/right-eye lens 3051, 3052 of the 3D glasses 305 is therefore increased, in order to increase the environment brightness received by the 3D glasses 305. Increasing the environment brightness received by the 3D glasses 305 may also achieve the effect of saving power.

Besides, to meet different requirements, when people are watching TV programs and the ambient environment brightness is darker, the processing unit 3401 knows a dark ambient environment (i.e., low ambient environment brightness) by detecting the light source of the external ambient environment, and then the ambient environment brightness received by the 3D glasses 305 is increased to save the power of the 3D glasses 305. The control signal generating unit 3402 finds out a corresponding increased environment brightness of the 3D glasses 305 by searching the look-up table and accordingly generates the control signal S_C, and then the control signal S_C is transmitted to the adjusting circuit 315. Therefore, the adjusting circuit 315 may increase the activation time of the left-eye lens/right-eye lens 3051, 3052 of the 3D glasses 305, in order to increase the ambient environment brightness received by the 3D glasses 305. Besides, supposing that the ambient environment brightness is low, it means that the user does not want to be disturbed when viewing images. Thus, in order to make the ambient environment brightness become darker for allowing the user to pay more attention to the images presented by the display device 310, the processing unit 3401 knows a dark environment (i.e., low environment brightness) by detecting the light source of the ambient environment. Next, the ambient environment brightness received by the 3D glasses 305 may be decreased. The control signal generating unit 3402 therefore finds out a corresponding decreased environment brightness of the 3D glasses 305 by searching the look-up table and accordingly generates the control signal S_C, and then the control signal S_C is transmitted to the adjusting circuit 315. Therefore, the adjusting circuit 315 may further decrease the activation time of the left-eye lens/right-eye lens 3051, 3052 of the 3D glasses 305, in order to decrease the ambient environment brightness received by the 3D glasses 305.

Besides, in the third exemplary embodiment, the processing unit 3401 is further utilized for receiving an instruction signal S_COM, and the control signal generating unit 3402 is utilized for analyzing the instruction signal S_COM to thereby generate the control signal S_C. When the analyzed instruction signal S_COM indicates enabling of the 3D glasses 305, the control signal S_C generated by the control signal generating unit 3402 indicates that a brightness is decreased, and when the analyzed instruction signal S_COM indicates disabling of the 3D glasses 305, the control signal S_C generated by the control signal generating unit 3402 indicates that a brightness is increased. Next, the following adjusting circuit 315 dynamically adjusts the activation time of the left-eye lens/right-eye lens 3051, 3052 according to the instruction of the control signal S_C, thereby dynamically increasing or decreasing the ambient environment brightness received by the 3D glasses 305. For example, the left-eye lens/right-eye lens 3051, 3052 maintain at a full-on state (i.e., the environment brightness is highest) when the 3D glasses 305 are not activated. When the instruction signal S_COM indicates that the 3D glasses 305 is activated (i.e., enabled), the control signal generating unit 3402 generates a control signal S_C after analyzing the instruction signal S_COM. According to the control signal S_C, the adjusting circuit 315 decreases the activation time of the left-eye lens/right-eye lens 3051, 3052, in order to decrease the environment brightness received via the 3D glasses 305. The adjusting manner thereof is to gradually reduce the received environment brightness for allowing user's eyes to be gradually adapted to the brightness adjustment of the 3D glasses 305; however, gradually decreasing the received environment brightness is not meant to be a limitation of the present invention.

Moreover, after the 3D glasses 305 are activated for viewing of the stereo images, the left-eye lens/right-eye lens 3051, 3052 will not simultaneously stay in the full-on state in which the environment brightness is highest. Therefore, when the instruction signal S_COM indicates that the 3D glasses 305 are shut down (i.e., disabled), the control signal generating unit 3402 generates the control signal S_C after analyzing the instruction signal S_COM. According to the control signal S_C, the adjusting circuit 315 increases the activation time of the left-eye lens/right-eye lens 3051, 3052, thereby increasing the environment brightness of the 3D glasses 305. The adjusting manner thereof is to gradually increase the received environment brightness light for allowing user's eyes to be gradually adapted to the brightness adjustment of the 3D glasses 305; however, gradually increasing the received environment brightness is not meant to be a limitation of the present invention. Please note that the content (e.g., enabling or disabling) indicated by the instruction signal S_COM described above is for illustrating one of the exemplary embodiments of the present invention, and is not meant to be a limitation of the present invention. Therefore, as long as any content of an instruction signal may make the 3D glasses achieve the objective of dynamically adjusting the environment brightness, such an instruction signal falls within the scope of the present invention.

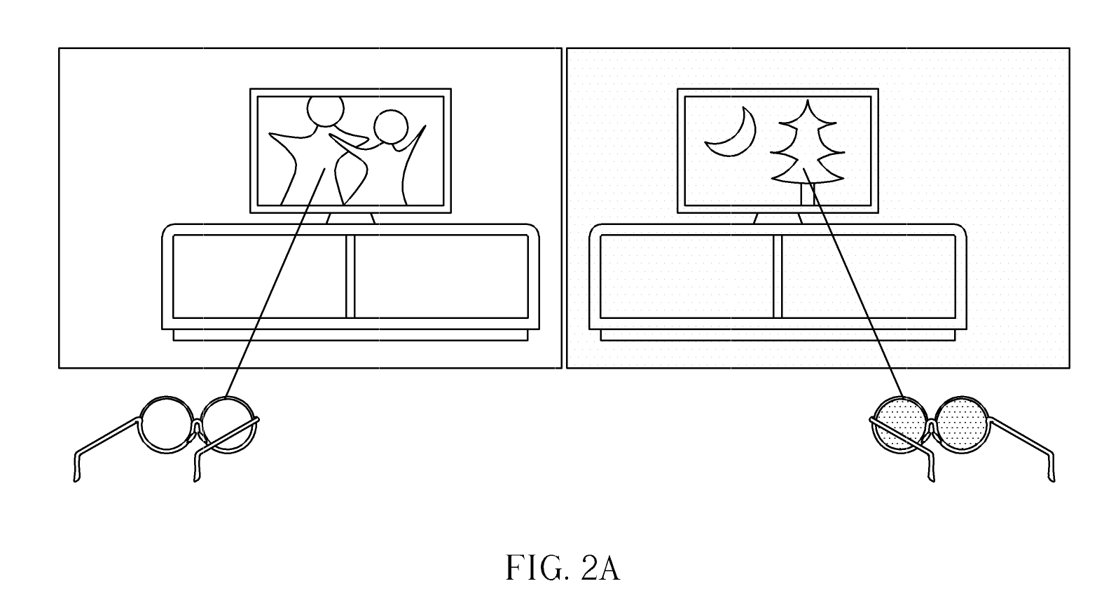

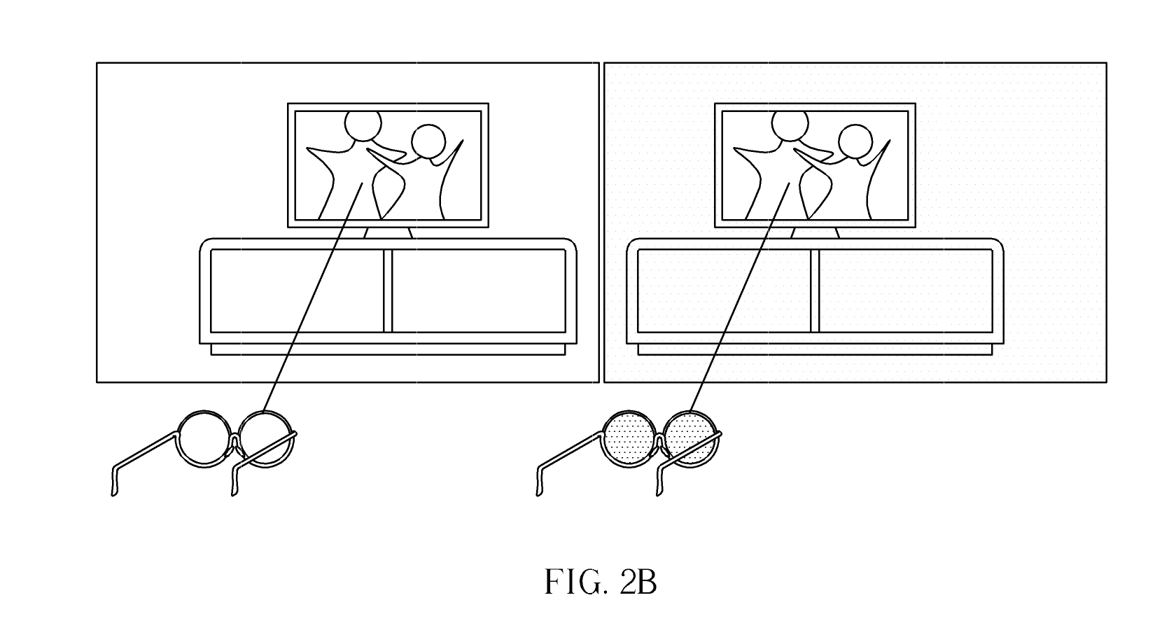

Besides, the video content described above is not limited to stereo images. In other words, the operation of dynamically adjusting the ambient environment brightness received by the 3D glasses 305 is not restricted to be applied to viewing of stereo images (3D images), and it may be applied to viewing of 2D images. For example, in another exemplary embodiment as shown in FIG. 2A, the video content includes a first 2D video (e.g., a program of a CNN news channel) and a second 2D video (e.g., a program of an HBO movie channel) which are played simultaneously, wherein the first 2D video occupies the playback timing of the left-eye images within the original stereo images, and the second 2D video occupies the playback timing of the right-eye images within the original stereo images. Therefore, the first 2D video and the second 2D video are alternately presented according to the manner of showing the left-eye images and the right-eye images. In other words, the user wearing the 3D glasses 305 will see the program of the CNN news channel at the playback timing of left-eye images, and see the program of the HBO movie channel at the playback timing of right-eye images. The video may be called Dual 2D video. The user can decide which channel to watch (i.e., select one of the first 2D video and the second 2D video as a viewed video). For example, when the user decides to view the second 2D video (i.e., the program of the HBO movie channel), the left-eye lens and right-eye lens 3051, 3052 of the 3D glasses 305 both act at the same time and are only turned on at the playback timing of right-eye images (corresponding to the second 2D video). Thus, user's eyes will see the program of the HBO movie channel rather than the first 2D video (e.g., the program of the CNN news channel), and vice versa.

No matter which 2D video the user decides to view, the adjusting circuit 315 is capable of dynamically adjusting the activation time of the left-eye lens/right-eye lens 3051, 3052, in order to dynamically adjust the ambient environment brightness received by the 3D glasses 305. Therefore, different 2D videos would correspond to different environment brightness. For example, when user's eyes are watching the first 2D video (e.g., the program of a news channel), the activation time of the left-eye lens/right-eye lens 3051, 3052 corresponds to a first time, and when user's eyes are watching the second 2D video (e.g., the program of a movie channel), the activation time of the left-eye lens/right-eye lens 3051, 3052 corresponds to a second time, where the first time is longer than the second time. As shown in FIG. 2A, when the 3D glasses 305 are utilized for viewing images (e.g., the program of the CNN news channel) according to playback timing of left-eye images, the environment brightness received by the 3D glasses 305 is higher to thereby collaborate with the image brightness of the program of the news channel, and when the 3D glasses 305 are utilized for viewing images (e.g., the program of the HBO movie channel) according to playback timing of right-eye images, the environment brightness received by the 3D glasses 305 is lower to thereby collaborate with the image brightness of the program of the movie channel.

Besides, the 3D glasses 305 in this exemplary embodiment may also be employed in a situation where the display device 310 is displaying stereo images but the 3D glasses 305 are operated under a 2D image viewing mode. For example, please refer to FIG. 2B. The left-eye lens and right-eye lens 3051, 3052 of the 3D glasses 305 in this exemplary embodiment are both utilized for viewing images according to the playback timing of left-eye images (i.e., operated under the 2D image viewing mode). The adjusting circuit 315 dynamically adjusts the activation time of the left-eye lens/right-eye lens 3051, 3052, thereby dynamically adjusting the ambient environment brightness received by the 3D glasses 305. For example, the adjusting circuit 315 may refer to the ambient environment brightness to adjust the brightness received via the lens.

Please note that the device 325 that has the control circuit 340 is disposed within the display device 310 in this exemplary embodiment. In other words, the display device 310 has the ability of analyzing images and detecting the light source of the ambient environment. In this way, the 3D glasses 305 passively receives the control signal S_C transmitted from the display device 310 and acts according to the received control signal S_C, leading to lower production cost. Besides, the control signal S_C generated from the display device 310 to the 3D glasses 305 may be a control signal that directly controls the on/off status of the lenses of the 3D glasses 305, or may be an ambient environment brightness control signal and a synchronization signal of the 3D glasses 305.

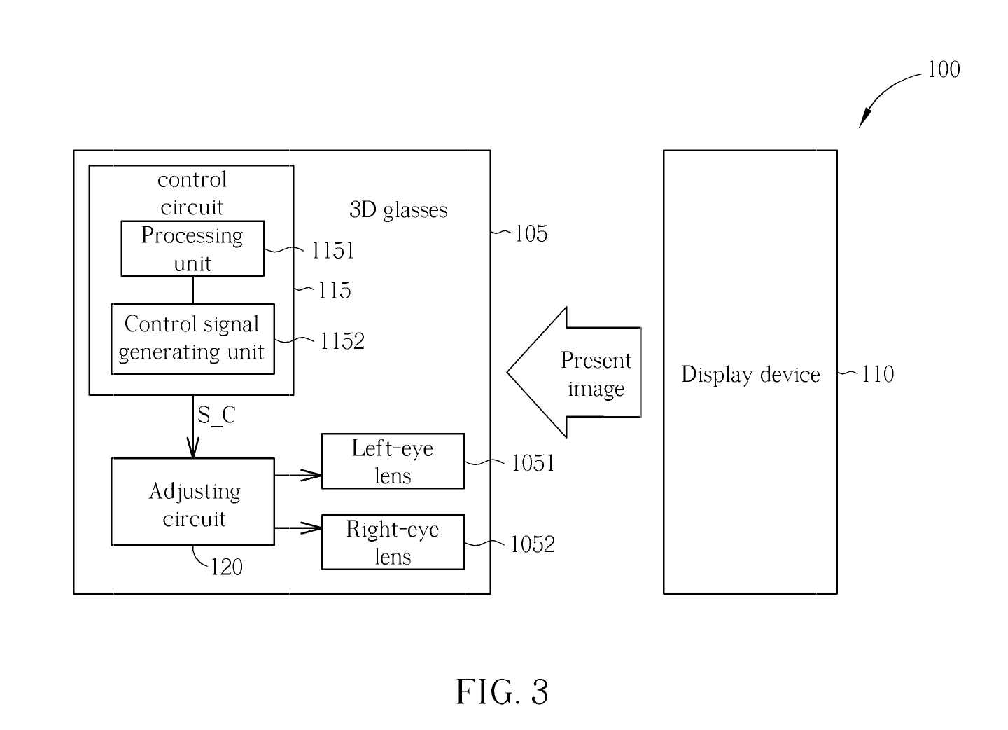

Please refer to FIG. 3, which is a diagram of the image display system 100 according to a second exemplary embodiment of the present invention. The image display system 100 includes 3D glasses 105 and a display device 110. The 3D glasses 105 include a control circuit 115, an adjusting circuit 120, a left-eye lens 1051 and a right-eye lens 1052. The control circuit 115 includes a processing unit 1151 and a control signal generating unit 1152, wherein the operation and function of the left-eye lens 1051, the right-eye lens 1052 and the adjusting circuit 120 are similar to that of the left-eye lens 3051, the right-eye lens 3052 and the adjusting circuit 315, and the operation and function of the processing unit 1151 and the control signal generating unit 1152 are similar to that of the processing unit 3401 and the control signal generating unit 3402. Further description is omitted here for brevity.

The difference between the exemplary embodiments shown in FIG. 1A and FIG. 3 is that the control circuit 112 shown in FIG. 3 is disposed within the 3D glasses 105 rather than the display device 110. Therefore, the 3D glasses 105 may analyze the image variation and detect the light source variation of the ambient environment by itself. As to analyzing of the image variation, the 3D glasses 105 process raw data directed generated from the display device 110 or metadata derived from analysis performed by the display device 110. Besides, the 3D glasses 105 also need to receive a synchronization signal emitted by the display device 110 for performing the image analysis. As to detecting of the light source of the ambient environment, the 3D glasses 105 has a built-in sensor (e.g., a light source sensor, such as a photo diode or a photo sensor, which can convert the light source brightness into an electrical signal) to detect the brightness of the light source in the ambient environment, and the 3D glasses 105 also need to receive a synchronization signal emitted by the display device 110 for performing the image analysis.

Besides, in addition to directly receiving images of the video content (e.g., a plurality of brightness values) to calculate a brightness variation, the processing unit 1151 may indirectly estimate the brightness variation by detecting the image variation of the video content, and then the control signal generating unit 1152 generates the control signal S_C according to the estimated brightness variation. In other words, the processing unit 1151 estimates a brightness variation by detecting the image brightness of the video content (step 235), and the control signal generating unit 1152 generates the control signal S_C according to the image brightness variation estimated by the processing unit 1151 (step 240). When the control signal generating unit 1152 knows an image brightness of the video content is increased (i.e., a current image brightness of the video content is higher than a brightness value previously detected), the control signal generating unit 1152 outputs the control signal S_C for indicating that the activation time of the 3D glasses 105 needs to be increased; on the contrary, when the control signal generating unit 1152 knows an image brightness of the video content is decreased (i.e., a current image brightness of the video content is lower than a brightness value previously detected), the control signal generating unit 1152 outputs the control signal S_C for indicating that the activation time of the 3D glasses 105 needs to be decreased. Therefore, when the control signal S_C indicates that a brightness is increased, the adjusting circuit 120 increases the activation time of the 3D glasses 105 to thereby increase the environment brightness received by the 3D glasses 105. When the control signal S_C indicates that a brightness is decreased, the adjusting circuit 120 decreases the activation time of the 3D glasses 105 to thereby decrease the environment brightness received by the 3D glasses 105. Please note that the processing unit 1151 used for detecting the image brightness is disposed within the 3D glasses 105. However, the installation location is not limited to a position that is exactly at the front surface of the 3D glasses 105 (more image brightness variation may be detected by placing the processing unit 1151 at the front surface of the 3D glasses). The processing unit 1151 may be disposed at any location on the 3D glasses 105 as long as the processing unit 1151 is able to detect the image brightness variation. For example, the processing unit 1151 may be disposed at one side on the 3D glasses 105.

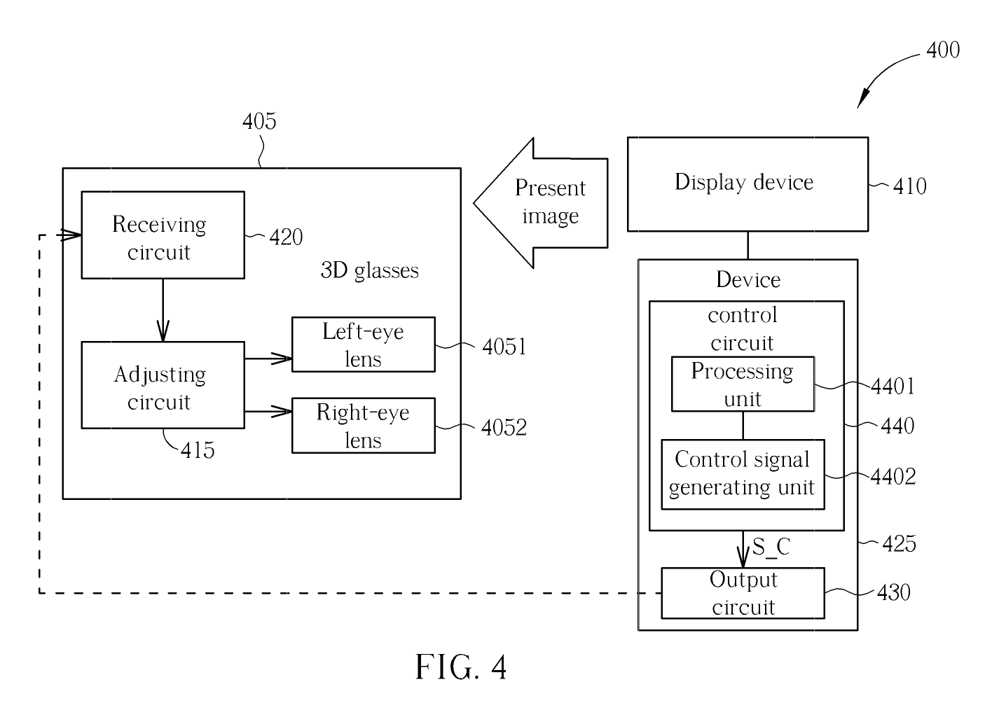

Please refer to FIG. 4, which is a diagram of the image display system 400 according to a third exemplary embodiment of the present invention. The image display system 400 includes 3D glasses 405, a display device 410 and a device 425 for controlling the environment brightness received by the 3D glasses 405, wherein the 3D glasses 405 include a left-eye lens 4051, a right-eye lens 4052, an adjusting circuit 415 and a receiving circuit 420, the device 425 includes an output circuit 430 and a control circuit 440, and the control circuit 440 includes a processing unit 4401 and a control signal generating unit 4402. The operation and function of the left-eye lens 4051, the right-eye lens 4052 and the adjusting circuit 415 are similar to that of the left-eye lens 3051, the right-eye lens 3052 and the adjusting circuit 315 shown in FIG. 1A, and the operation and function of the processing unit 4401 and the control signal generating unit 4402 are similar to that of the processing unit 3401 and the control signal generating unit 3402 shown in FIG. 1A. Further description is omitted here for brevity.

The difference between the exemplary embodiments shown in FIG. 4 and FIG. 3 is that the device 425 shown in FIG. 4 is externally coupled to the display device 410 rather than disposed within the display device 410. For example, the device 425 may be an external device, a transmitter or a remote control. However, this is not meant to be a limitation of the present invention. For example, when the external device 425 directly transmits the control signal S_C to the 3D glasses 405 or the display device 410 by instructions/commands, the 3D glasses 405 may directly receive an instruction or a command to perform the operation of adjusting the received brightness of the ambient environment light source. For example, a software engine developer of a software company (e.g., a game company) may define a preset command used for controlling the brightness of the ambient environment light source. Therefore, a game developer may develop a program which can judge occurrence of a scenario where the brightness of the ambient environment light source should be dynamically adjusted. When the program judges that the scenario occurs during the execution of the software, the program transmits the preset command to the 3D glasses 405. For example, the game developed by the game develop is a shooting game. When the shooting game's player is attacked by a flash bang during the game playing, the program developed by the game developer judges that the current scenario needs to dynamically adjust the brightness of the ambient environment light source. The preset command defined by the software engine developer is transmitted to the 3D glasses 405, so that the 3D glasses 405 estimates or detects the image variation of the shooting game to dynamically adjust the brightness of the environment light source according to the preset command. Thus, when the shooting game's player is attacked by a flash bang during the game playing, the player may have realistic visual experience due to the 3D glasses 405 dynamically adjusting the brightness of the environment light source. This is for illustrative purposes only, and is not meant to be a limitation of the present invention.

Those skilled in the art will readily observe that numerous modifications and alterations of the device and method may be made while retaining the teachings of the invention.

What is claimed is:

1. A method for controlling an ambient environment brightness received by three-dimensional (3D) glasses, the 3D glasses being utilized for viewing an image presented by a display device, the method comprising:
generating a control signal according to at least one of image variations of a video content presented by the display device, an external ambient environment brightness and an instruction signal for controlling operations of the 3D glasses; and
adjusting an activation time of the 3D glasses to adjust the ambient environment brightness received by the 3D glasses according to the control signal.

2. The method of claim 1, wherein the step of adjusting the activation time of the 3D glasses according to the control signal comprises:
when the control signal indicates that a brightness is increased, increasing the activation time of the 3D glasses; and
when the control signal indicates that the brightness is decreased, decreasing the activation time of the 3D glasses.

3. The method of claim 2, wherein the step of generating the control signal comprises:
detecting a plurality of brightness values of the video content for estimating a brightness variation, and generating the control signal according to the estimated brightness variation;
wherein when the brightness values indicate that the brightness is increased, the control signal indicates that the activation time needs to be increased; and when the brightness values indicate that the brightness is decreased, the control signal indicates that the activation time needs to be decreased.

4. The method of claim 1, wherein the image presented by the display device is a two-dimensional (2D) video content; the video content comprises a first 2D video and a second 2D video, and the first 2D video and the second 2D video are alternately presented on the display device according to a manner of showing left-eye images and right-eye images; and the step of generating the control signal comprises:
selecting one of the first 2D video and the second 2D video as a viewed video;
when the first 2D video is selected as the viewed video, detecting a brightness variation of the first 2D video to generate a first control signal for indicating a first activation time of the 3D glasses; and
when the second 2D video is selected as the viewed video, detecting a brightness variation of the second 2D video to generate a second control signal for indicating a second activation time of the 3D glasses;
wherein the first activation time is different from the second activation time.

5. The method of claim 1, wherein the step of generating the control signal comprises:
when the instruction signal indicates that enabling of the 3D glasses, the control signal indicating the brightness is decreased; and
when the instruction signal indicates that disabling of the 3D glasses, the control signal indicating the brightness is increased.

6. 3D glasses for controlling an ambient environment brightness received by the 3D glasses, the 3D glasses being utilized for viewing an image presented by a display device, the 3D glasses comprising:
a control circuit, arranged for generating a control signal according to at least one of image variations of a video content presented by the display device, an external ambient environment brightness and an instruction signal for controlling operations of the 3D glasses; and
an adjusting circuit, coupled to the control circuit, for adjusting an activation time of the 3D glasses to adjust the ambient environment brightness received by the 3D glasses according to the control signal.

7. The 3D glasses of claim 6, wherein when the control signal indicates that a brightness is increased, the adjusting circuit increases the activation time of the 3D glasses; and when the control signal indicates that a brightness is decreased, the adjusting circuit decreases the activation time of the 3D glasses.

8. The 3D glasses of claim 7, wherein the control circuit comprises:
a processing unit, arranged for estimating a brightness variation by receiving a plurality of brightness values of the video content, detecting the plurality of brightness values of the video content, or detecting the external ambient environment brightness; and
a control signal generating unit, arranged for generating the control signal according to the estimated brightness variation.

9. The 3D glasses of claim 7, wherein the control circuit comprises:
a processing unit, arranged for receiving the instruction signal; and
a control signal generating unit, arranged for analyzing the received instruction signal to generate the control signal;
wherein when the instruction signal indicates that enabling of the 3D glasses, the control signal indicates the brightness is decreased; and when the instruction signal indicates that disabling of the 3D glasses, the control signal indicates the brightness is increased.

10. The 3D glasses of claim 6, wherein the video content comprises a first 2D video and a second 2D video, and the first 2D video and the second 2D video are alternately presented on the display device according to a manner of showing left-eye images and right-eye images; when the first 2D video is selected as a viewed video, the control circuit estimates a brightness variation of the first 2D video, and generates a first control signal for indicating a first activation time of the 3D glasses; when the second 2D video is selected as the viewed video, the control circuit estimates a brightness variation of the second 2D video, and generates a second control signal for indicating a second activation time of the 3D glasses; and the first activation time is different from the second activation time.

11. 3D glasses for controlling an ambient environment brightness received by the 3D glasses, the 3D glasses being utilized for viewing an image presented by a display device, the 3D glasses comprising:
a receiving circuit, for receiving a control signal which is inputted externally; and
an adjusting circuit, coupled to the receiving circuit, for adjusting an activation time of the 3D glasses to adjust the ambient environment brightness received via the 3D glasses according to the control signal received by the adjusting circuit;
wherein the control signal corresponds to image variations of a video content presented by the display device, an external ambient environment brightness or an instruction signal for controlling an operation of the 3D glasses.

12. A device for controlling an ambient environment brightness received by 3D glasses, the 3D glasses being utilized for viewing an image presented by a display device, the device comprising:
a control circuit, for generating a control signal according to image variations of a video content presented by the display device, an external ambient environment brightness or an instruction signal for controlling operations of the 3D glasses; and
an output circuit, coupled to the control circuit, for outputting the control signal to the 3D glasses;
wherein the control signal is utilized for adjusting an activation time of the 3D glasses to adjust the ambient environment brightness received via the 3D glasses.

13. The device of claim 12, wherein when the control signal indicates that a brightness is increased, the activation time of the 3D glasses is increased; and
when the control signal indicates that the brightness is decreased, the activation time of the 3D glasses is decreased.

14. The device of claim 13, wherein the control circuit comprises:
a processing unit, arranged for estimating a brightness variation by receiving a plurality of brightness values of the video content, detecting the plurality of brightness values of the video content, or detecting the external ambient environment brightness; and
a control signal generating unit, arranged for generating the control signal according to the estimated brightness variations.

15. The device of claim 13, wherein the control circuit comprises:
a processing unit, arranged for receiving the instruction signal; and
a control signal generating unit, arranged for analyzing the received instruction signal to generate the control signal;
wherein when the instruction signal indicates that enabling of the 3D glasses, the control signal indicates the brightness is decreased; and when the instruction signal indicates that disabling of the 3D glasses, the control signal indicates the brightness is increased.

16. The device of claim 12, wherein the video content comprises a first 2D content and a second 2D video, and the first 2D video and the second 2D video are alternately presented on the display device according to a manner of showing left-eye images and right-eye images; when the first 2D video is selected as a viewed video, the control circuit estimates a brightness variation of the first 2D video, and generates a first control signal for indicating a first activation time of the 3D glasses; when the second 2D video is selected as the viewed video, the control circuit estimates a brightness variation of the second 2D video, and generates a second control signal for indicating a second activation time of the 3D glasses; and the first activation time is different from the second activation time.

17. The device of claim 12, being disposed within the display device.

18. The device of claim 12, being coupled to the display device externally.
